(19) United States
(12) Patent Application Publication
(10) Pub. No.: US 2008/0022070 A1
(43) Pub. Date: Jan. 24, 2008

(54) Programmable image readout sequencer

(75) Inventors: Peter A. Deruytere, Herent (BE); Werner G. C. Ogiers, Leest (BE)

Correspondence Address: BLAKELY SOKOLOFF TAYLOR & ZAFMAN, 1279 OAKMEAD PARKWAY, SUNNYVALE, CA, 94085-4040, US

(73) Assignee: Cypress Semiconductor Corporation

(21) Appl. No.: 11/492,286

(22) Filed: Jul. 24, 2006

(51) Int. Cl. G06F 9/30; H04N 5/225; G06F 9/40; H04N 9/04; G06F 15/00

(52) U.S. Cl. 712/200; 348/207.99

(57) ABSTRACT

A programmable sequencer for a solid-state image sensor provides hard/soft configurable control of imaging operations in an imaging core.

### TECHNICAL FIELD

Embodiments of the present invention relate to image sensors and, in particular, to the programmable control of readout and reset operations in image sensors.

### BACKGROUND

Solid-state image sensors have found widespread use in digital camera systems. Solid-state image sensors use an array of picture elements (pixel array), typically arranged in rows and columns, to convert electromagnetic (EM) energy (e.g., infrared, visible light, ultraviolet light, x-rays, etc) into a charge or current that can be detected and processed to generate a digital image. While many different semiconductor processing technologies may be used to produce solid-state image sensors (e.g., NMOS, PMOS and BiCMOS), the two principle technologies used for solid-state image sensors are CMOS (complementary metal-oxide semiconductor) technology and CCD (charge-coupled device) technology.

FIG. 1 illustrates a conventional CMOS image sensor. The image sensor includes an imaging core that produces an analog output. The imaging core includes a pixel matrix, which is an array of picture elements (pixels), arranged in rows and columns, and peripheral circuits that control the operation of the pixel array. Some pixel arrays, used in linear image sensors, may consist of a single row (or column) of pixels. Other pixel arrays may have thousands of rows and columns and millions of pixels. Each pixel generates a charge or current proportional to the EM energy it receives.

Each pixel in a CMOS pixel array contains a photosensitive element and at least one switching element to select/deselect the pixel for readout and/or reset operations as described below. The photosensitive element may be, for example, a photodiode, a photogate or a phototransistor. Typically, the switching elements in CMOS image sensors are MOSFET (metal-oxide semiconductor field-effect transistor) devices. CMOS pixels may be passive or active. A passive pixel typically contains only the photosensitive element and a single switching element. An active pixel may contain additional elements (e.g., 2 or more MOSFET transistors) to perform signal amplification and buffering within the pixel.

The imaging core also includes row-addressing circuitry to select rows for readout and reset operations, and column/pixel-addressing circuitry to select pixels for sequential readout. Typical addressing circuitry can include one-hot shift registers, one-hot shift registers with programmable start addresses, programmable decoders, etc. The row-addressing circuitry selects rows by generating row select signals on row select lines. Some image sensors may also include row reset lines for each row. When a row is selected by the row-addressing circuitry, each pixel in the selected row is connected to a column output line. Then, as the column-addressing circuitry sequentially scans the pixels in the selected row, the output signal from each pixel in the row is buffered and/or amplified by a column amplifier in each column. The column amplifiers may perform other operations, such as ordinary or correlated double-sampling to eliminate fixed-pattern noise. The outputs of the column amplifiers are multiplexed onto an output bus and buffered by a buffer amplifier to produce an analog signal stream. Variations of this typical configuration may include more than one output bus and buffer amplifier.

The analog signal stream from the imaging core is converted to a digital data stream by an analog-to-digital converter (ADC). The digital data stream may be optionally processed by a post-processing module (e.g., the post-processing module may be used to perform color correction or pixel interpolation). An interface module handles input-output with external systems (e.g., a camera system) and takes care of protocols, handshaking, voltage conversions and the like.

The operations of the imaging core (i.e., the imaging core protocol) are controlled by a sequencer. The sequencer generates all of the logic signals that control row-addressing, column-addressing, operation of the column amplifiers and output buffer, and voltage multiplexing over the output bus. The sequencer also controls other components of the image sensor, such as the ADC and the post-processor. The sequencer may have to support high pixel rates. For example, a five million pixel (5 megapixel) imaging core, operating at 30 frames per second (FPS) has a pixel rate of 150 million pixels per second.

Conventional image sensors use sequencers that are configured as hardwired finite state machines (FSM) to control the operations of the imaging core as well as other components of the image sensor. The output(s) of a finite state machine depends only on the current state of the FSM, the input(s) to the FSM and designed-in state transition rules of the FSM. In the case of conventional image sensors, the FSM sequencer may accept a system clock signal and a few control signals from the interface module (e.g., enable, disable). Otherwise, the timing and duration of the control signals generated by the sequencer are fixed and the only performance variable is scaling through built-in counters and/or delay lines and/or input clock rate changes.

Typically, the design of a FSM sequencer is performed after its corresponding imaging core has been designed, or even fabricated and characterized. Detailed knowledge of the performance of the analog pixel array (and other analog circuitry), obtained through in-lab characterization, may be required before the design of the sequencer can be finalized. Any adjustments to the nominal imaging core protocol that are required to achieve the best possible performance from the imaging core will impact the design of the sequencer. As a result of this sequential design process, the overall design cycle time is extended.

### BRIEF DESCRIPTION OF THE DRAWINGS

The present invention is illustrated by way of example, and not by way of limitation, in the figures of the accompanying drawings in which:

FIG. 1 illustrates a conventional CMOS image sensor;

FIG. 2A illustrates a passive pixel in one embodiment;

FIG. 2B illustrates the operation of a passive pixel in one embodiment;

FIG. 3A illustrates an active pixel in one embodiment;

FIG. 3B illustrates the operation of an active pixel in one embodiment;

FIG. 4 illustrates a programmable sequencer in one embodiment;

FIG. 5A illustrates an initial imaging core protocol in one embodiment;

FIG. 5B illustrates a modified imaging core protocol in one embodiment;

FIG. 6 is a table illustrating a set of exemplary programming commands for a programmable sequencer in one embodiment;

FIG. 7 is a table illustrating an exemplary mapping of instruction bits to imaging core signals in one embodiment;

FIG. 8 is a table illustrating a sequence of programmable sequencer instructions corresponding to the initial imaging core protocol of FIG. 5A.

FIG. 9 is a table comparing the instruction sequence of FIG. 8 with a sequence of programmable sequencer instructions corresponding to the modified imaging core protocol of FIG. 5B;

FIG. 10A is a listing of pseudo code corresponding to the instruction sequence of FIG. 8;

FIG. 10B is a listing of pseudo code corresponding to the modified instruction sequence of FIG. 9;

FIG. 11 is a flowchart illustrating a method of manufacture in one embodiment; and

FIG. 12 is a block diagram illustrating an image sensor system in one embodiment.

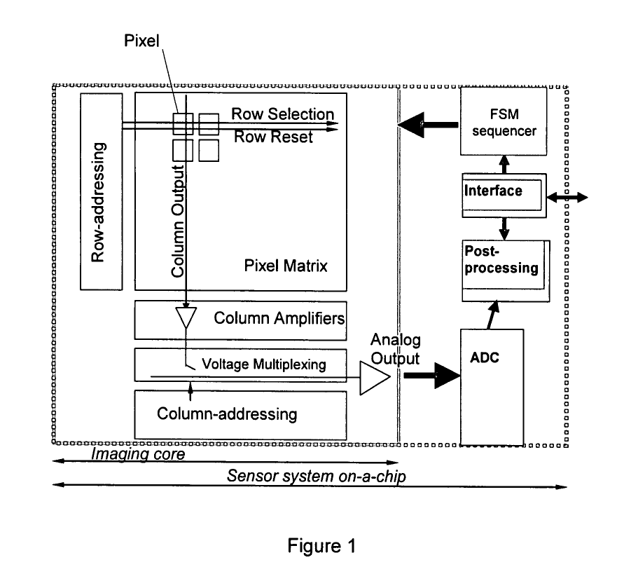

### DETAILED DESCRIPTION

In the following description, numerous specific details are set forth, such as examples of specific commands, named components, connections, data structures, etc., in order to provide a thorough understanding of embodiments of the present invention. It will be apparent, however, to one skilled in the art that embodiments of present invention may be practiced without these specific details. In other instances, well known components or methods have not been described in detail but rather in a block diagram in order to avoid unnecessarily obscuring the present invention. Thus, the specific details set forth are merely exemplary. The specific details may be varied from and still be contemplated to be within the spirit and scope of the present invention.

Some portions of the description that follow are presented in terms of algorithms and symbolic representations of operations on data bits that may be stored within a memory and operated on by a processing device. These algorithmic descriptions and representations are the means used by those skilled in the art to effectively convey their work. An algorithm is generally conceived to be a self-consistent sequence of acts leading to a desired result. The acts are those requiring manipulation of quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, parameters or the like.

The term “coupled to” as used herein may mean coupled directly to or indirectly to through one or more intervening components. Any of the signals provided over various buses described herein may be time multiplexed with other signals and provided over one or more common buses. Additionally, the interconnection between circuit components or blocks may be shown as buses or as single signal lines. Each of the buses may alternatively be one or more single signal lines, and each of the single signal lines may alternatively be buses.

In the following descriptions, CMOS image sensors are used to describe exemplary embodiments of the invention for ease of discussion. Those skilled in the art will recognize that the methods, apparatus and systems described herein may also be applied to other solid-state image sensor technologies such as CCD, NMOS, PMOS and BiCMOS.

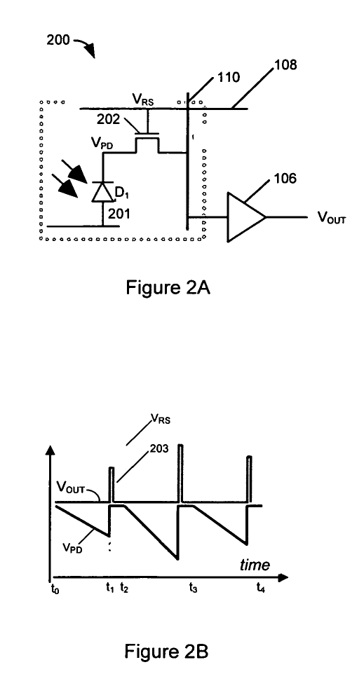

FIG. 2A illustrates a passive pixel 200 in one embodiment. In FIG. 2A, the photosensitive device is a photodiode (D₁) 201 and the switching element is an MOS transistor 202 connected between photodiode 201 and column bus 110. MOS transistor 202 is controlled by row select line 108, which is connected to the gate of MOS transistor 202. FIG. 2B illustrates the operation of passive pixel 200 in one embodiment. In FIG. 2B, V_{PD} is the photodiode voltage (negative for the diode orientation shown), V_{OUT} is the output voltage of column amplifier 106 and V_{RS} is the row select signal on row select line 108. At time t₀, V_{RS} is zero so that photodiode 201 is not connected to column bus 110. From t₀ to t₁, photodiode 201 is exposed to EM energy (e.g., by the operation of a camera shutter, not shown) and generates a photocharge. The photocharge accumulates on a floating diffusion capacitance (not shown) at the junction of photodiode 201 and MOS transistor 202, generating voltage V_{PD}. At time t₁, the row select voltage V_{RS} is asserted, turning on MOS transistor 202 and connecting photodiode 201 to column bus 110. The floating diffusion capacitance discharges through MOS transistor 202, resetting the photodiode voltage V_{PD} to zero and generating a voltage pulse 203 at the output of column amplifier 106. At t₂, the row select voltage is de-asserted, turning off MOS transistor 202. The sequence is repeated from t₂ to t₃, from t₃ to t₄ and so on while the image sensor is operating.

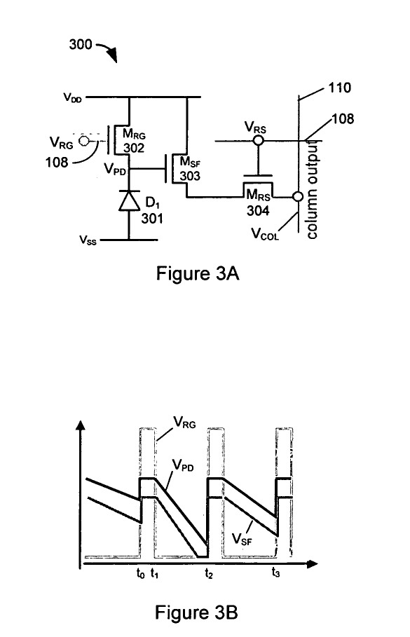

FIG. 3A illustrates a three transistor (3T) active pixel 300 in one embodiment and FIG. 3B illustrates the corresponding operation of active pixel 300. Active pixel 300 includes a photodiode (D₁) 301 and three MOSFET devices including a reset gate (M_{RG}) 302, a source follower (M_{SF}) 303, and a row select switch (M_{RS}) 304.

As noted above, D₁ is used to generate charge proportional to the incident EM energy. The reverse bias capacitance of photodiode D₁ is used to store the charge and convert it to a photodiode voltage V_{PD}. Reset gate M_{RG} is used to precharge the photodiode. When a reset voltage pulse V_{RG} is asserted at to on reset line 110 at the gate of M_{RG}, photodiode D₁ is reverse-biased and the reverse-biased capacitance of D₁ is precharged to positive supply voltage V_{DD} (less the drain-source voltage drop across M_{RG}). When V_{RG} is de-asserted at t₁ and photodiode D₁ is exposed to EM energy, photodiode D₁ generates charge. During the exposure period from t₁ to t₂, the charge is integrated on the reverse-biased capacitance of D₁ and the voltage V_{PD} of photodiode D₁ decreases as illustrated in FIG. 3B.

Source follower M_{SF} buffers the photodiode voltage V_{PD} to a floating diffusion capacitance (not shown) between M_{SF} and M_{RS}, developing voltage V_{SF}. Row select voltage V_{RS} may then be asserted to generate an output pulse as described above with respect to the passive pixel 200. Alternatively, the row select signal may be asserted during the integration period from t₁ to t₂ so that the column voltage V_{COL} tracks the source follower voltage V_{SF}. This reset-readout cycle is repeated from t₂ to t₃ and so on for each pixel in the pixel array, where the individual pixel outputs are time-multiplexed as described above. Other operational variations of 3T pixels and other pixel architectures are known in the art. For example, 4T and 5T pixels may be implanted. Additional control signals and sequences may also be implemented as part of the read and reset cycles used with 3T, 4T and 5T pixels

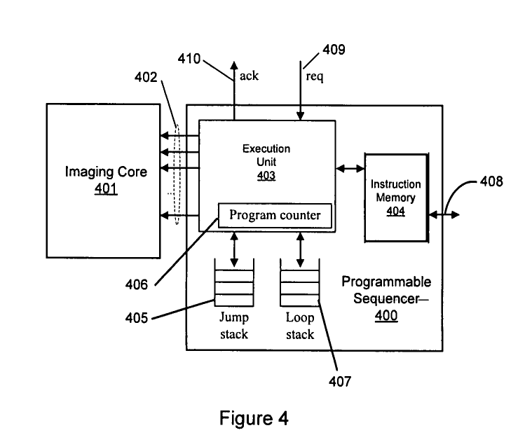

FIG. 4 illustrates a programmable sequencer 400 in one embodiment, coupled with an imaging core 401, that may be used to provide configurable control of read and reset operations of passive and/or active pixels (e.g., such as pixels 200 or 300 described above) in an imaging core 401. In one embodiment, programmable sequencer 400 may include an execution unit 403. Execution unit 403 may be a microprocessor with a limited instruction set dedicated to program flow control and no data processing. Execution unit 403 may be configured to read instructions from an instruction memory 404 and provide control signals 402 for the imaging core 401. Instruction memory 404 stores instructions which define the imaging core protocol for the imaging core 401, including row addressing, row reset, row select, intra-pixel signal transfers, column addressing, column readout and column amplifier operation. Execution unit 403 may also include a program counter 406 to hold the address of the next instruction in instruction memory 404 to be executed by execution unit 403.

In one embodiment, the programmable sequencer 400 may also include a jump stack 405, coupled with the execution unit 403, which may be read by program counter 406. Jump stack 405 may be configured to hold the return addresses of jump instructions in instruction memory 404, which may be used by execution unit 403 to selectively execute read and reset instruction subroutines from instruction memory 404 as read and reset operations (or subsets thereof) in imaging core 401. Programmable sequencer 400 may also include a loop stack 407, coupled with execution unit 403, which may be read by program counter 406. Loop stack 407 may be configured to hold loop counts and addresses of entry points for instruction sequences in instruction memory 404, which may be used by execution unit 403 to selectively repeat read and reset instructions from instruction memory 404 as read and reset operations (or subsets thereof) in imaging core 401. In one embodiment, jump stack 405 and loop stack 407 may be last-in, first-out (LIFO) stacks as are known in the art.

In one embodiment, as described in greater detail below, programmable sequencer 400 may also include a programming interface 408 to instruction memory 404. Programmable sequencer 400 may also include I/O (input-output) lines such as request (REQ) line 409 and acknowledgement (ACK) line 410 to perform handshaking with external systems.

Instruction memory 404 may be any one of several different memory types for storing program instructions. For example, instruction memory 404 may be read-only or non-volatile or volatile writable memory. Instruction memory 404 may be implemented as conventional memory (e.g., SRAM, ROM, EEPROM) or in the form of registers, flip-flops, latches, etc. as are known in the art.

In one embodiment, the instruction memory may be made of registers, which may be configured from flip-flops. The default power-on values of the registers may be defined such that they can be modified by one or more metal mask changes in the manufacturing process of the programmable sequencer 400. The instructions for the programmable sequencer may be modified by writing the registers externally (e.g., via programming interface 408), or by re-designing the one or more metal mask layers that generate the desired program code for the programmable sequencer as default values for the registers (i.e., non-volatile at time of manufacture).

In one embodiment, the instruction memory may be volatile writable memory such as SRAM, for example, in which case the instructions for the programmable sequencer may be uploaded at boot-up by writing to the memory externally as described above in the case of registers.

In one embodiment, the instruction memory may be read-only memory. The instructions for the programmable sequencer may be modified by changing that portion of the design that defines the contents of the memory, which for the case of ROM may be accomplished with a low number of mask changes (e.g., one to three) at the time of manufacture.

In one embodiment, the instruction memory may be non-volatile programmable memory (e.g., EPROM, EEPROM, OTPROM, flash memory). The instructions for the programmable sequencer may be modified by writing the memory externally as described above at either the time of manufacture or in the field.

The basic operation of execution unit 403 includes fetching an instruction word from instruction memory 404 at an address indicated by program counter 406, decoding the instruction word (command and arguments), executing the decoded instruction and updating the program counter (incrementing or assigning a new value based on the instruction, e.g., a jump or loop instruction). There may be two types of instruction word. One type of instruction word is a program flow control instruction word affecting the execution flow of the programmable sequencer itself. The other type of instruction word is the description of signal values or patterns that are to be applied by the sequencer to the imaging core (i.e., the actual payload of the program). The second type of instruction word dictates what signals are applied. The first and second types together determine when the signals are applied.}

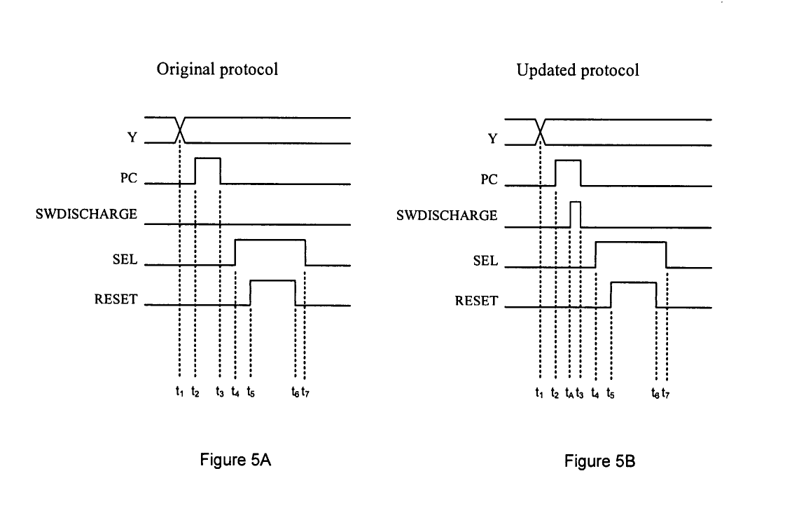

FIGS. 5A and 5B illustrate a simplified example of how a programmable sequencer, such as programmable sequencer 400, may be used to modify an imaging core protocol to improve image quality in a solid-state image sensor without a lengthy redesign cycle time. It will be appreciated that a real imaging core protocol sequence may involve many more control signals and more complex timing than illustrated in FIGS. 5A and 5B. It will be appreciated, however, that the aspects of the invention illustrated in FIGS. 5A and 5B may be applied to any imaging core protocol, regardless of its complexity. FIG. 5A illustrates an example of an initial imaging core protocol designed, for example, in parallel with the development of an imaging core architecture. In the simplified imaging core protocol of FIG. 5A, the protocol begins with the assertion of a line address signal Y at t₁. Following the line address signal, a precharge signal (PC) is asserted from t₂ to t₃ to preconditioning the column buses in the imaging core. From t₄ to t₇, a row select signal (SEL) is asserted to connect a selected row of pixels, indicated by address Y, to their respective column buses as described above. Then, within the row select window, the line of pixels in the addressed line is reset from t₅ to t₆ as described above.

It may be possible that the initial imaging core protocol does not produce an image of the best quality. For example, the image may be affected by second order effects within the imaging core (e.g., crosstalk, delay, parasitic leakage, drift of high-impedance nodes, etc.) that cannot be modeled with a simulation tool during the design phase, and which can only be eradicated by first experimenting on the fabricated silicon circuit. In a conventional image sensor, using a hard-wired FSM, a new sequencer would have to be designed, requiring a whole new mask set and significant time and expense. In one embodiment, a programmable sequencer may be used to experimentally discover a correction for an error in the initial protocol, to debug the design of the imaging core or to optimize the ultimate image quality. Then, the programmable sequencer may be reprogrammed to implement a change without generating a new mask set. For example, in the case described above, and illustrated in FIG. 5A, it may be determined experimentally that the image quality can be improved by performing a switch discharge operation in the column amplifiers during the precharge period. In this example, a switch discharge operation preconditions a particular series of capacitors that is normally used to store some of the pixel signals at selected times and unused at other times. During the other times, the voltage on the capacitors may drift (e.g., due to leakage, crosstalk from nearby switching signals, etc.). Preconditioning the capacitors, prior to using them for active signal storage, sets them to a fixed state that clears their signal history. A programmable sequencer, such as programmable sequencer 400 may then be used to make the desired change. FIG. 5B illustrates a modified imaging core protocol in one embodiment. FIG. 5B illustrates how a switch discharge signal (SWDISCHARGE) may be asserted from time t_{A} to time t₃. It will be appreciated that the program modification described herein is merely exemplary and that program modifications may be made to any and/or all of the signals controlled by embodiments of the programmable sequencer described herein.

Programming instructions in instruction memory 404 may be defined and formatted in many ways as are known in the art. In the following discussion, a particular binary instruction format is used for convenience of explanation. It will be appreciated by one of ordinary skill in the art that other formats are possible.

An instruction may be an instruction word that may include a command and an argument. The content and length of the argument may depend on the command. The command may be, for example, a 5-bit string and the argument may vary between zero and 11 bits such that each instruction may be a 16 bit word.

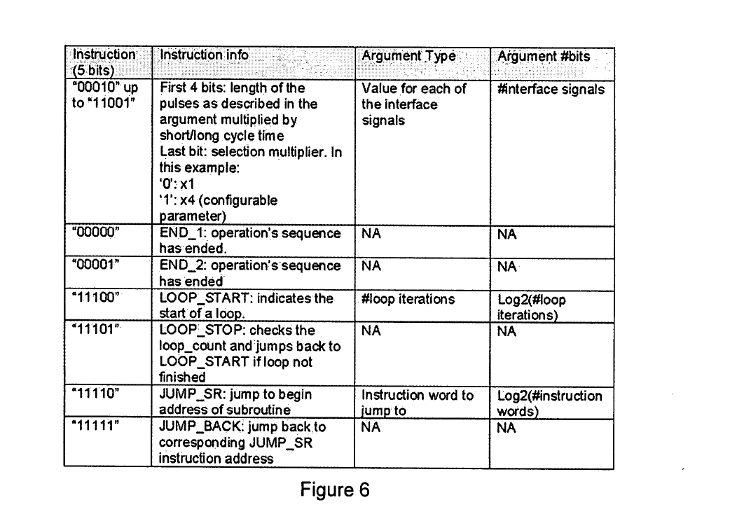

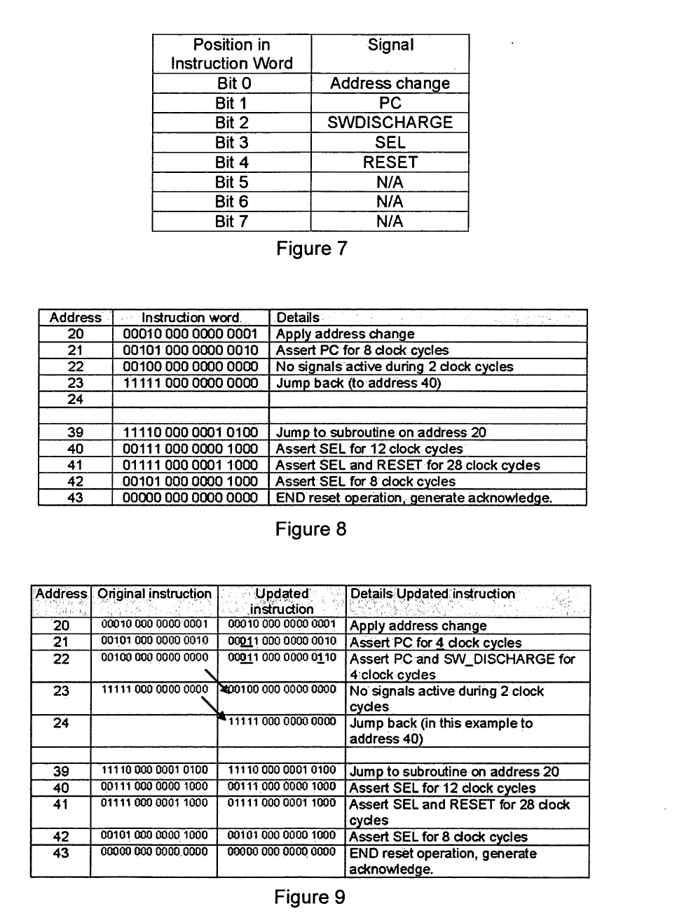

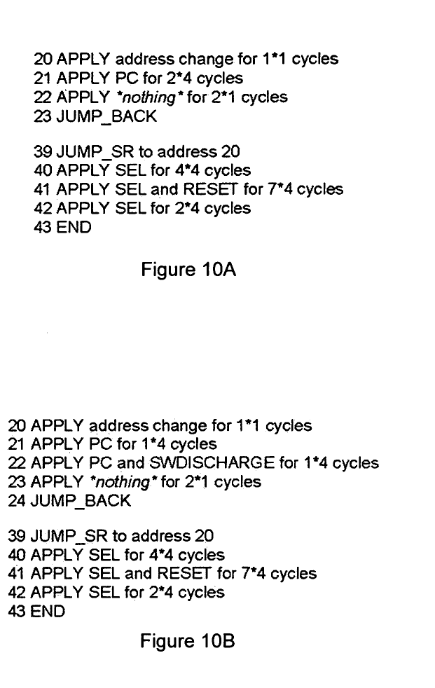

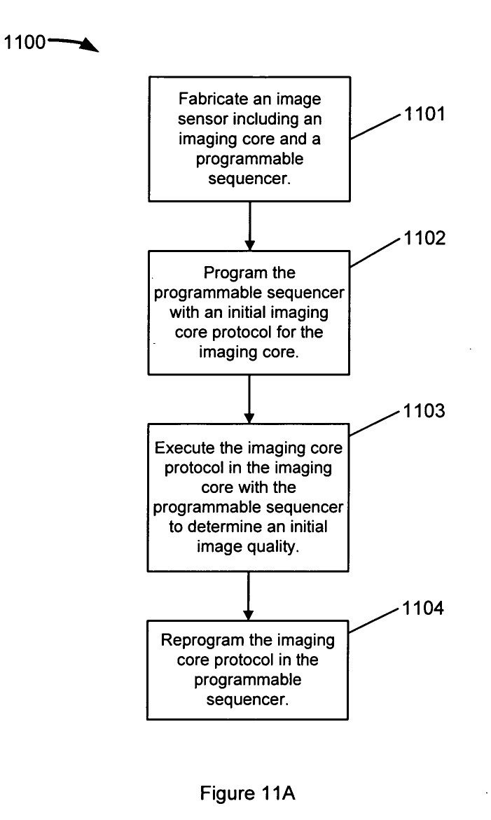

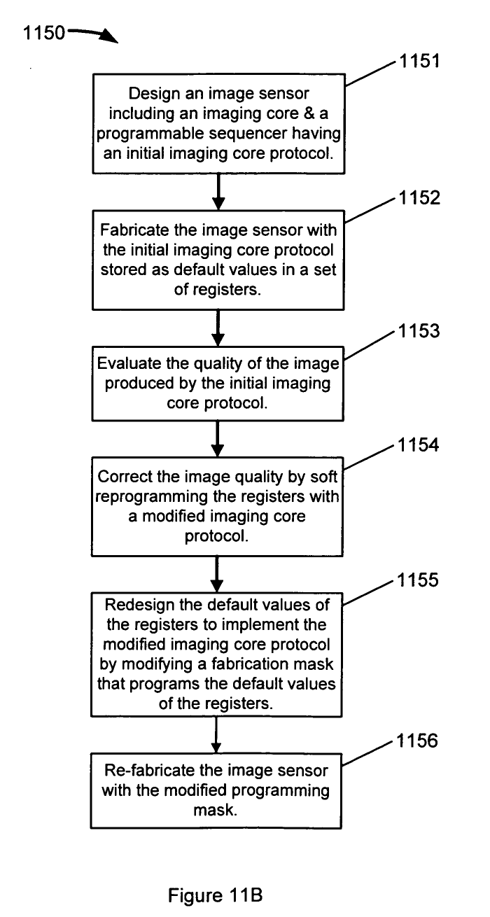

FIG. 6 is a table illustrating a set of exemplary programming commands for a programmable sequencer in one embodiment. In FIG. 6 illustrates an exemplary command structure which includes signal pattern values and pattern duration descriptors, operation termination commands, loop start and stop commands and subroutine jump and return commands as are known in the art, and corresponding argument types and lengths. FIG. 7 is a table illustrating an exemplary mapping of coded instruction bits to actual imaging core signals in one embodiment. FIG. 8 is a table illustrating a sequence of programmable sequencer instructions corresponding to the original imaging core protocol of FIG. 5A and FIG. 9 is a table comparing the instruction sequence of FIG. 8 with a sequence of programmable sequencer instructions corresponding to the modified imaging core protocol of FIG. 5B. FIG. 10A is a listing of pseudo-code corresponding to the instruction sequence of FIG. 8, and FIG. 10B is a listing of pseudo code corresponding to the modified instruction sequence of FIG. 9.

It will be appreciated, therefore, that embodiments of the programmable sequencer described herein may be programmed to debug and/or improve the performance of an imaging core design. Embodiments of the programmable sequencer described herein may also be programmed to compensate and/or correct for intentional design changes within an imaging core or to correct and/or compensate for unintentional design errors within an imaging core.

FIG. 11A is a flowchart illustrating a manufacturing method 1100 for an image sensor in one embodiment of the present invention having a soft programmable instruction memory (e.g., an externally programmable volatile or non-volatile memory such as RAM, EEPROM, flash memory or the like). In operation 1 101, an image sensor including an imaging core and a programmable sequencer are fabricated, based on an initial design simulation for example. In operation 1102, the programmable sequencer is programmed with an initial imaging core protocol. In operation 1103, the imaging core protocol is executed in the imaging core to extract an image from the imaging core to determine an initial image quality. In operation 1104, the imaging core protocol in the programmable sequencer is reprogrammed to correct errors in the initial imaging core protocol and/or to debug the imaging core and/or to improve/optimize the image quality}.

FIG. 11B is a flowchart illustrating a manufacturing method 1150 for an image sensor in one embodiment of the present invention having a hard/soft programmable instruction memory (e.g., a register-based memory including programmable flip-flops, latches or the like). In operation 1151, an initial image sensor design is executed, including an imaging core and a programmable sequencer with an initial default program (i.e., initial imaging core protocol). The initial program may be, for example, a functional imaging core protocol or a null program (i.e., no instructions). In operation 1152, the initial design of the image sensor is fabricated, where the initial imaging core protocol is stored as the default values of a set of registers. In operation 1153, the quality of the image produced by the default imaging core protocol is evaluated. In operation 1154, the image quality is corrected (e.g., to correct design errors in the imaging core, debug the default imaging core protocol or optimize the image for uncontrolled variables) by programming the registers via a programming interface (i.e. soft programming) to implement a modified imaging core protocol. In operation 1155, the default values of the registers are redesigned by modifying a fabrication mask that programs the default register pattern to conform to the modified imaging core protocol. In operation 1156, the image sensor is remanufactured with the modified programming mask.

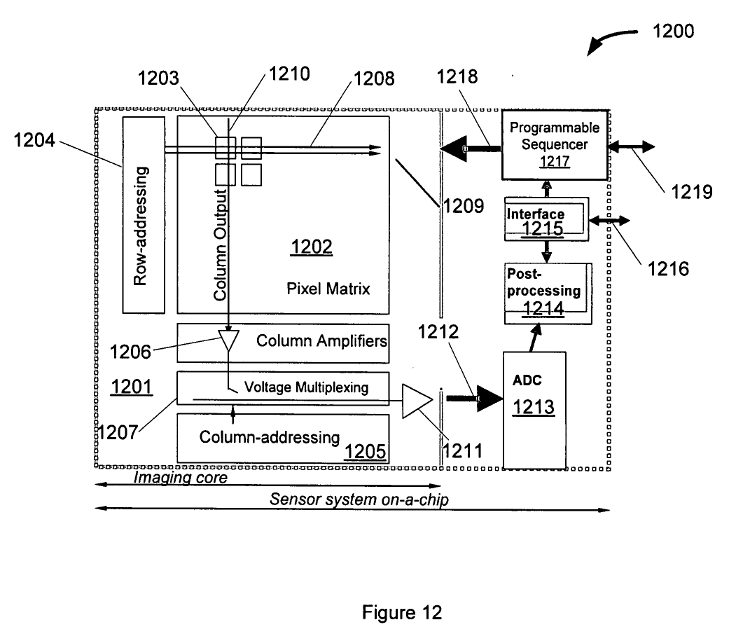

FIG. 12 is a block diagram of an image sensor system 1200 in which embodiments of the present invention may be implemented. The image sensor system 1200 includes an imaging core 1201 coupled having a control interface 1218 and a programming interface 1219. The imaging core is coupled with a programmable sequencer, as described above, via control interface 1218. Programmable sequencer 1217 is configured to provide configurable control of the imaging core protocol in imaging core 1201 as described above. The imaging core includes a pixel array 1202, which is an array of picture elements (pixels) such as pixel 1203, arranged in rows and columns.

Also included in the imaging core 1201 are a row-addressing circuitry 1204, to select rows of the pixel array, a column-addressing circuitry 1205 to scan the pixels in the selected row, column amplifiers such as column amplifier 1206, to buffer and amplify the signals in each column, and a multiplexed output bus 1207. The column amplifiers may include double-sampling circuitry (not shown) to eliminate fixed-pattern noise in the pixel array. Row-addressing circuitry 1204 selects rows by generating row select signals on row select lines, such as row select line 1208. Some image sensors may also include row reset lines for each row, such as row reset line 1209. When a row is selected by the row-addressing circuitry 1204, each pixel in the selected row is connected to a column bus, such as column bus 1210, feeding into the column amplifiers. Then all of the pixels in the line are simultaneously processed, and stored, in the column amplifiers (such as column amplifiers 1206). Then, as the column-addressing circuitry 1205 scans the selected row (e.g., from left to right), the output signal from each column amplifier is time-multiplexed onto output bus 1207, one column output at a time. The output bus 1207 is buffered by a buffer amplifier 1211 to produce an analog signal stream 1212

The analog signal stream 1212 from imaging core 1201 is converted to a digital data stream by an analog-to-digital converter (ADC) 1213. The digital data stream may be optionally processed by a post-processing module 1214 (e.g., the post-processing module may be used to perform color correction or pixel interpolation). An interface module 1215 handles input-output with external systems (e.g., a camera system) and takes care of protocols, handshaking, voltage conversions and the like.

The programmable sequencer discussed herein may be used in various applications. In one embodiment, the programmable sequencer discussed herein may be used in a digital camera system, for example, for general-purpose photography (e.g., camera phone, still camera, video camera) or special-purpose photography. Alternatively, the programmable sequencer discussed herein may be used in other types of applications, for example, machine vision, document scanning, microscopy, security, biometry, etc.

While some specific embodiments of the invention have been shown the invention is not to be limited to these embodiments. The invention is to be understood as not limited by the specific embodiments described herein, but only by scope of the appended claims.

What is claimed is:

1. An apparatus, comprising:
an imaging core; and
a programmable sequencer, coupled with the imaging core, to provide configurable control of an imaging core protocol.

2. The apparatus of claim 1, wherein the programmable sequencer comprises:
an instruction memory including instructions for the imaging core protocol; and
an execution unit, coupled with the instruction memory, to read the instructions and to execute the imaging core protocol in the imaging core.

3. The apparatus of claim 2, wherein the programmable sequencer further comprises a programming interface to program the instruction memory.

4. The apparatus of claim 2, wherein the programmable sequencer further comprises a program counter to hold an address of an instruction in the instruction memory to be executed by the execution unit.

5. The apparatus of claim 2, wherein the programmable sequencer further comprises a jump stack coupled with the processing device, the jump stack to hold return addresses of jump instructions in the instruction memory to be selectively executed by the execution unit as read and reset operation subroutines in the imaging core.

6. The apparatus of claim 2, wherein the programmable sequencer further comprises a loop stack coupled with the execution unit, the loop stack to hold loop counts and addresses of entry points for instruction sequences in the instruction memory to be selectively repeated by the execution unit as read and reset operations in the imaging core.

7. The apparatus of claim 3, wherein the instruction memory comprises one or more field programmable registers, and wherein the field programmable registers are programmable via the programming interface.

8. The apparatus of claim 3, wherein the instruction memory comprises one or more programmable registers, wherein the programmable registers are externally programmable via the programming interface and programmable by one or more mask changes.

9. The apparatus of claim 3, wherein the instruction memory comprises read-only memory (ROM), wherein the ROM is programmable with a mask change.

10. The apparatus of claim 9, wherein the ROM comprises a programmable ROM (PROM), wherein the PROM is programmable via the programming interface.

11. The apparatus of claim 3, wherein the instruction memory comprises random access memory (RAM), wherein the RAM is programmable via the programming interface.

12. A method of manufacturing an image sensor, comprising:
designing an image sensor including an imaging core and a programmable sequencer with an initial imaging core protocol;
fabricating the image sensor with the initial imaging core protocol; and
executing the initial imaging core protocol to extract an image from the imaging core and to determine an initial image quality.

13. The method of claim 12, wherein fabricating the image sensor comprises hardware programming the initial imaging core protocol in the image sequencer with a fabrication mask configuration.

14. The method of claim 13, wherein the initial imaging core protocol comprises a null program.

15. The method of claim 12, further comprising reprogramming the imaging core protocol in the programmable sequencer with a modified imaging core protocol via a software programming interface to improve the initial image quality.

16. The method of claim 15, further comprising re-fabricating the image sensor with the modified imaging core protocol, wherein re-fabricating the image sensor comprises hardware programming the modified imaging core protocol in the image sequencer with a reconfigured fabrication mask.

17. The method of claim 16, wherein hardware programming comprises programming one or more instruction registers with the reconfigured fabrication mask.

18. The method of claim 16, wherein hardware programming comprises programming a read only memory with the reconfigured fabrication mask.

19. The method of claim 15, wherein reprogramming the imaging core protocol comprises uploading an instruction set to random access memory via a programming interface.

20. An apparatus, comprising:
means for capturing a digital image; and
means for hard programming an initial imaging core protocol to obtain the digital image from the means for capturing the digital image; and
means for soft reprogramming the initial imaging core protocol into a modified imaging core protocol for obtaining the digital image.

21. The apparatus of claim 20, further comprising means for hard programming the modified imaging core protocol.

22. A system, comprising:
an imaging core;
a programmable sequencer, coupled with the imaging core, to provide configurable control of an imaging core protocol;
an analog-to-digital (ADC) converter coupled with the imaging core to convert outputs from the imaging core to a digital data stream;
an image-processing module coupled with the ADC to perform digital processing on the digit data stream; and
an interface module coupled with the programmable sequencer and the image-processing module to provide a data, command and control, and power interface.
